(19) United States
(12) Patent Application Publication
(10) Pub. No.: US 2026/0304482 A1
(43) Pub. Date: Oct. 1, 2026

(54) RESOURCE RECEPTION IN TXSPG OPERATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/574,157

(22) Filed: Mar. 20, 2026

Related U.S. Application Data
(60) Provisional application No. 63/781,058, filed on Mar. 31, 2025.

(51) Int. Cl. H04W 74/0816; H04L 5/00; H04W 8/22; H04W 28/02

(52) U.S. Cl. CPC H04W 74/0816; H04L 5/0053; H04W 8/22; H04W 28/0268

(57) ABSTRACT

Methods and apparatuses for transmission opportunity (TXOP) sharing for peer to peer (P2P) group (TXSPG) operation. A method performed by a non-access point (AP) station (STA) includes receiving, from an AP, a multi-user (MU)-request to send (RTS) TXOP sharing (TXS) trigger frame; determining whether the MU-RTS TXS trigger frame includes a common info field with a TXS mode field equal a value and a user info field including an identifier associated with a P2P group of the non-AP STA; and transmitting, based on determining that the MU-RTS TXS trigger frame includes the common info field with the TXS mode field equal the value and the user info field including the identifier associated with the P2P group of the non-AP STA, a clear to send (CTS) frame a short interframe space (SIFS) time after an end of a physical layer protocol data unit (PPDU) carrying the MU-RTS TXS trigger frame.

### CROSS-REFERENCE TO RELATED APPLICATIONS AND CLAIM OF PRIORITY

This application claims priority under 35 U.S.C. § 119 (e) to U.S. Provisional Patent Application No. 63/781,058 filed on Mar. 31, 2025. The above-identified provisional patent application is hereby incorporated by reference in their entirety.

### TECHNICAL FIELD

This disclosure relates generally to wireless networks. More specifically, this disclosure relates to resource reception in transmission opportunity (TXOP) sharing for peer to peer (P2P) group (TXSPG) operation.

### BACKGROUND

WLAN technology allows devices to access the internet in the 2.4 GHZ, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for resource reception in TXSPG operation.

In one embodiment, a method performed by a non-access point (AP) station (STA) is provided. The method includes receiving, from an AP, a multi-user (MU)-request to send (RTS) TXOP sharing (TXS) trigger frame; determining whether the MU-RTS TXS trigger frame includes a common info field with a TXS mode field equal a value and a user info field including an identifier associated with a P2P group of the non-AP STA; and transmitting, based on determining that the MU-RTS TXS trigger frame includes the common info field with the TXS mode field equal the value and the user info field including the identifier associated with the P2P group of the non-AP STA, a clear to send (CTS) frame a short interframe space (SIFS) time after an end of a physical layer protocol data unit (PPDU) carrying the MU-RTS TXS trigger frame.

In another embodiment, a method performed by an AP is provided. The method includes transmitting, to a non-AP STA, a MU-RTS TXS trigger frame; and receiving, when the MU-RTS TXS trigger frame includes a common info field with a TXS mode field equal a value and a user info field including an identifier associated with a P2P group of the non-AP STA, a CTS frame a SIFS time after an end of a PPDU carrying the MU-RTS TXS trigger frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIG. 3 illustrates an example network where infrastructure traffic and non-infrastructure traffic coexist according to embodiments of the present disclosure;

FIG. 4A illustrates an example of format of a P2P element according to embodiments of the present disclosure;

FIG. 4B illustrates an example of control field format according to embodiments of the present disclosure;

FIG. 4C illustrates an example of P2P Group Info field format according to embodiments of the present disclosure;

FIG. 5A illustrates an example of high efficiency (HE) variant User Info field format in the MU-RTS TXS Trigger frame according to embodiments of the present disclosure;

FIG. 5B illustrates an example of extremely high throughput (EHT) variant User Info field of MU-RTS TXS Trigger frame according to embodiments of the present disclosure;

FIG. 6 illustrates an example method performed by a non-AP STA according to embodiments of the present disclosure; and

FIG. 7 illustrates an example method performed by an AP according to embodiments of the present disclosure.

### DETAILED DESCRIPTION

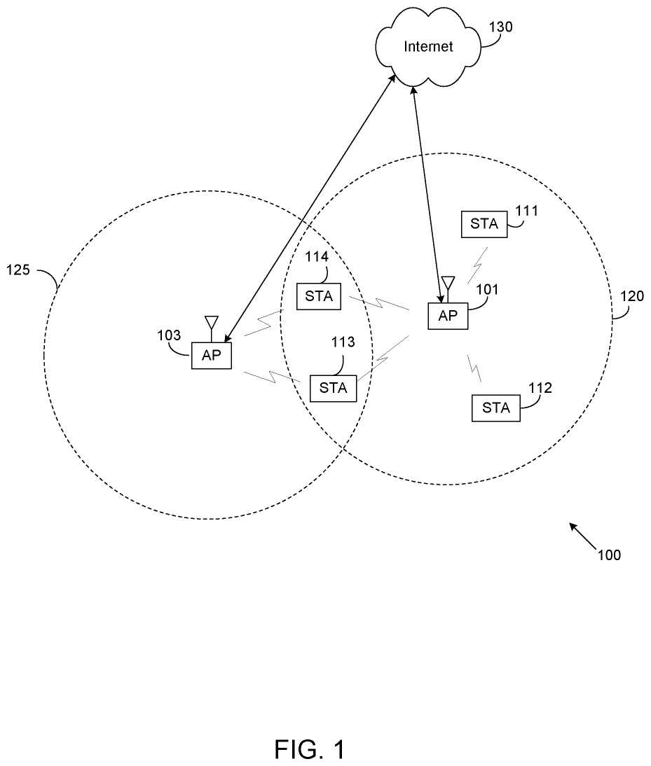

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an AP and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be—D3.0 “Part 11: Wireless LAN Medium Access Control (MAC) and Physical Layer (PHY) Specifications—Amendment 8: Enhancements for extremely high throughput (EHT)” and [2] IEEE P802.11REVme-D2.1″Part 11: Wireless LAN Medium Access Control (MAC) and Physical Layer (PHY) Specifications.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting a resource reception in TXSPG operation. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

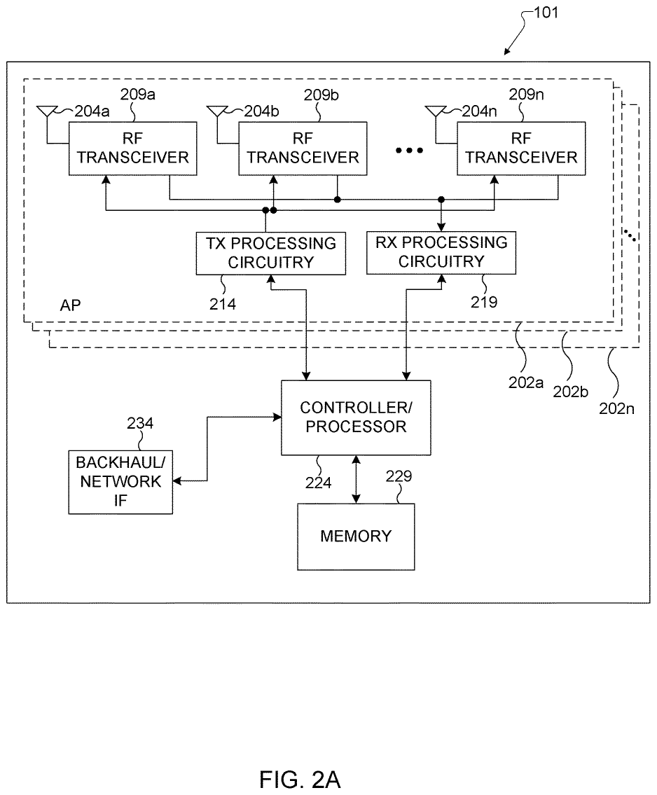

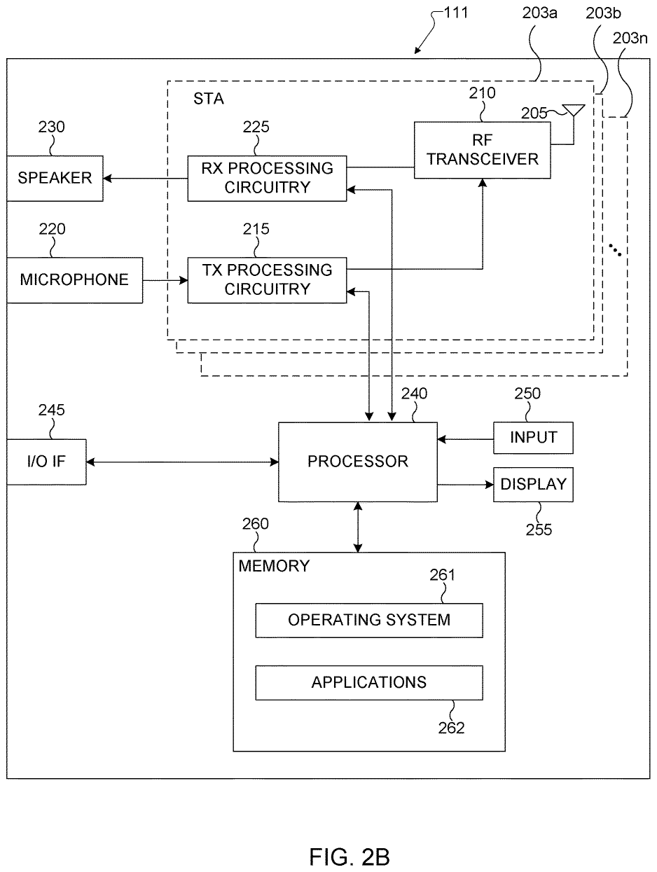

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In one or more of the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including resource reception in TXSPG operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for resource reception in TXSPG operation. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In one or more of the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate resource reception in TXSPG operation. In some embodiments, the processor 240 includes at least one microprocessor or microcontroller.

The processor 240 is also capable of executing other processes and programs resident in the memory 260, such as operations for resource reception in TXSPG operation. The processor 240 can move data into or out of the memory 260 as required by an executing process. In some embodiments, the processor 240 is configured to execute a plurality of applications 262, such as applications for resource reception in TXSPG operation. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize and take into consideration that support for low-latency applications is desired in WLAN systems. Numerous devices may operate on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure basic service set (BSS).

Some of the unmanaged traffic that interfere with the AP's BSS' latency sensitive traffic may be coming from uplink (UL)/downlink (DL) or direct link communications within the infrastructure BSS that the AP manages. Other's traffic interference may be due to transmission in the neighboring infrastructure BSS (OBSS). Yet other's traffic interference may be coming from neighboring independent BSS or P2P networks.

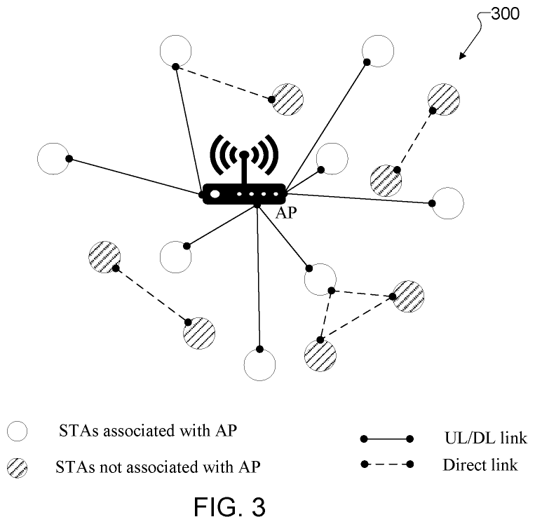

FIG. 3 illustrates an example network 300 where infrastructure traffic and non-infrastructure traffic coexist according to embodiments of the present disclosure. The network 300 is an example of the network 100 in FIG. 1. The network 300 is for illustration only and other embodiments can be used without departing from the scope of the present disclosure.

As illustrated, various STAs are present in the network 300. Certain of the STAs are connected to or associated with the AP. In this manner, the traffic between the associated STAs and the APs may be considered infrastructure traffic. Others of the STAs in the network 300 are not associated with the AP and may communicate directly with one another and/or with an associated STA using P2P communication. P2P communication represents a significant advancement in IEEE 802.11 WLANs, commonly known as Wi-Fi. Wi-Fi networks may rely on an AP to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

There are multiple benefits of P2P groups. By eliminating the need for an AP, they reduce latency and conserve battery life on devices. This makes them good for scenarios requiring real-time communication or energy efficiency. Additionally, P2P groups enable innovative applications such as smart home systems and IoT networks, where direct device interaction is important.

Despite these advantages, embodiments of the present disclosure recognize that challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, may provide some framework for these P2P capabilities. These standards ensure compatibility and security, often incorporating encryption methods like WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

Various embodiments of the present disclosure recognize and take into consideration that TXSPG is an important feature for IEEE 802.11bn (Wi-Fi) and that the AP's behavior for TXOP sharing is not clear and needs to be clarified. Accordingly, various embodiments of the present disclosure provide a mechanism for TXOP reception by a non-AP STA for TXSPG procedures.

In various embodiments, if a TXSPG non-AP STA receives an MU-RTS TXS Trigger frame from its associated AP that contains all (or one or more) of the following—
A Common Info field with the TXS Mode field set to a value (e.g., 3),
A User Info field addressed to a TXSPG Requesting STA of the P2P group in which the non-AP STA is a member, and/or
The P2P Group ID field of the User Info field is set to the P2P group ID of the P2P group in which the non-AP STA is a member,
then the non-AP STA, shall transmit a CTS frame a SIFS after the end of the received PPDU carrying the trigger frame, and may initiate an EDCA backoff procedure for the transmission of one or more non-TB PPDUs within the time allocation indicated in the MU-RTS TXS trigger frame. The non-TB PPDUs can be addressed to the AP or to another STA. The TXSPG non-AP STA shall ensure that its PPDU transmission(s) and any expected responses fit entirely within the allocated time. The non-AP STA, after sending the CTS frame, shall ignore the intra-BSS network allocation vector (NAV) either until the end of the time allocation indicated in the MU-RTS TXS Trigger frame or until the allocated time is returned to the TXOP holder, whichever happened earlier.

In various embodiments, a TXSPG Requesting STA that received an MU-RTS TXS Trigger frame with TXOP Sharing Mode subfield equal to a value (e.g., 3) may transmit, within an allocated time, a quality of service (QoS) Data or QoS Null frame that includes an HE variant high throughput (HT) Control field with a command and status (CAS) Control subfield with the reverse direction grant (RDG)/More PPDU subfield equal to 0 to the associated AP from which it has received a ultra-high reliability (UHR) Capabilities element with the TXOP Return Support in TXSPG subfield set to 1. Otherwise, the STA shall not transmit such frame to its associated AP within the allocated time.

In various embodiments, a TXSPG STA in a P2P group addressed by a MU-RTS TXS Trigger frame shall ensure that its PPDU transmission(s) and any expected responses fit entirely within the allocated time.

After sending the CTS solicited by the MU-RTS TXS (e.g., Mode-3) Trigger frame, the TXSPG STA in the P2P group addressed by the trigger frame shall set the Duration/ID field of its frame(s) to a value that indicates a time no later than the ending time of the PPDU [+SigExt] carrying the MU-RTS TXS Trigger frame plus the allocated time duration in the Allocation Duration field of the soliciting MU-RTS TXS (Mode-3) Trigger frame. Within the time allocated by MU-R TXS Trigger frame, the TXSPG STA may transmit QoS Data frames, Management frames, and frames that assist the transmission of QoS Data and Management frames, e.g., RTS/CTS frames, sounding frames.

Various embodiments provide signaling for TXOP provisioning in TXSPG. For example, a protected UHR action field, in the octet immediately after the Category field, differentiates the Protected UHR Action frame formats. The Protected UHR Action field values associated with each frame format within the UHR category are defined in Table 1 below (Protected UHR Action field values).

TABLE 1
Protected UHR Action field values

| Value | Meaning | Time priority |
|---|---|---|
| 0 | TXSPG Provisioning | No |
| 1 | TXSPG Provisioning Response | No |
| 2-255 | | |

The Action field of the TXSPG Provisioning frame contains the information shown in Table 2 below (TXSPG Provisioning frame Action field format).

TABLE 2
TXSPG Provisioning frame Action field format

| Order | Information |
|---|---|
| 1 | Category |
| 2 | Protected UHR Action |
| 3 | Dialog Token |
| 4 | P2P element (see 9.4.2.xx (P2P element) |
| 5 | QoS Characteristics element (Optional) |

The Dialog Token field is defined in 9.4.1.12 of [1] (Dialog Token field). The Dialog Token field is set to a nonzero value chosen by the AP sending the TXSPG Provisioning frame to identify the TXSPG Provisioning/TXSPG Provisioning Response frames transaction.

The Action field of the TXSPG Provisioning Response frame contains the information shown in Table 3 below (TXSPG Provisioning Response frame Action field format).

TABLE 3
TXSPG Provisioning Response frame Action field format

| Order | Information |
|---|---|
| 1 | Category |
| 2 | Protected UHR Action |
| 3 | Dialog Token |
| 4 | Status Code |

The Protected UHR Action field is defined in table 1 above. The Dialog Token field is defined in 9.4.1.12 of [1] (Dialog Token field). The Dialog Token field is set to a nonzero value chosen by the non-AP STA sending the TXSPG Provisioning Response frame to identify the TXSPG Provisioning/TXSPG Provisioning Response frames transaction.

The Status Code field is defined in 9.4.1.9 of [1] (Status Code field) and is set to the value 0 (SUCCESS) or 141 (DENIED_TXSPG_PROVISIONING).

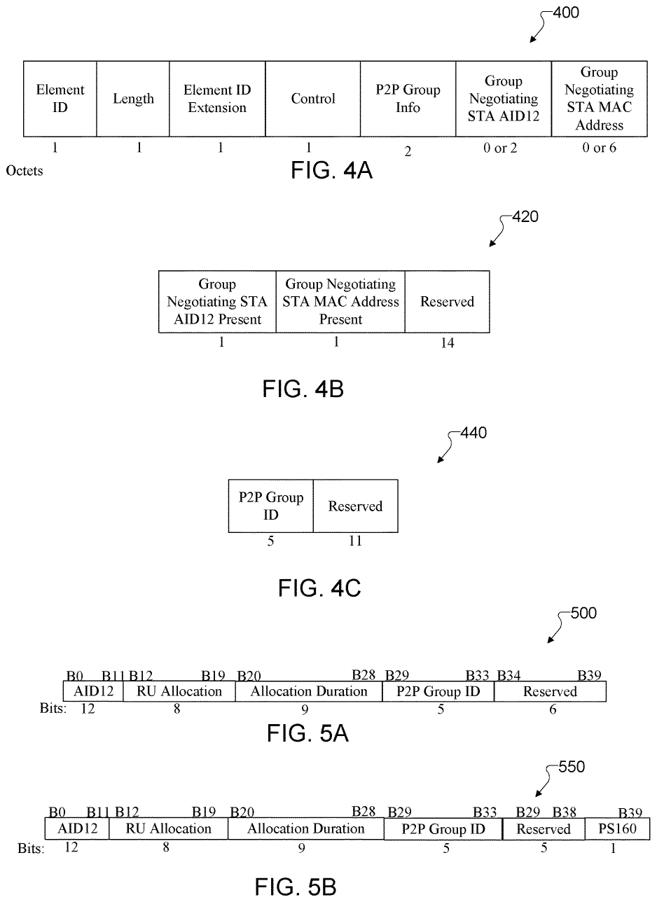

FIG. 4A illustrates an example of format of a P2P element 400 according to embodiments of the present disclosure. The embodiment of the format of a P2P element 400 shown in FIG. 4A is for illustration only. Other embodiments could be used without departing from the scope of this disclosure.

As shown in FIG. 4A, the P2P element 400 includes Element ID, Length, and Element ID Extension fields as defined in 9.4.2.1 of [1] (General). The control field format is shown in FIG. 4B

FIG. 4B illustrates an example of control field format 420 according to embodiments of the present disclosure. The embodiment of the control field format 420 shown in FIG. 4B is for illustration only. Other embodiments could be used without departing from the scope of this disclosure.

As shown in FIG. 4B, the control field format 420 includes a Group Negotiating STA AID12 Present subfield that indicates the presence of the Group Negotiating STA AID12 field in the P2P element. If the Group Negotiating STA AID12 Present subfield in the Control Info field is set to 1, then the Group Negotiating STA AID12 field is present in the P2P element; otherwise, the field is not present.

The Group Negotiating STA MAC Address Present subfield indicates the presence of the Group Negotiating STA MAC Address field in the P2P element. If the Group Negotiating STA MAC Address Present subfield in the Control Info field is set to 1, then the Group Negotiating STA MAC Address field is present in the P2P element; otherwise, the field is not present.

FIG. 4C illustrates an example of P2P Group Info field format 440 according to embodiments of the present disclosure. The embodiment of the P2P Group Info field format 440 shown in FIG. 4C is for illustration only. Other embodiments could be used without departing from the scope of this disclosure.

As shown in FIG. 4C, the P2P Group Info field format 440 includes a P2P Group ID subfield in the P2P Group Info field that indicates the P2P group ID assigned by the AP for the P2P group whose information is carried by the P2P element.

The Group Negotiating STA AID12 field, if present, indicates the AID12 value of the non-AP STA that performed the TXSPG negotiation with the AP for the P2P group identified by the P2P Group ID subfield.

The Group Negotiating STA MAC Address field, if present, indicates the MAC Address of the non-AP STA that performed the TXSPG negotiation with the AP for the P2P group identified by the P2P Group ID subfield.

Table 4 below provides definitions for values that may be included in the TXS Mode subfield in the MU-RTS Trigger frame format discussed in various embodiments herein.

TABLE 4
TXS Mode subfield encoding

| TXS | |
|---|---|
| Mode | |
| subfield | |
| value | Description |
| 0 | MU-RTS that does not initiate TXS procedure. |
| 1 | MU-RTS that initiates TXS procedure wherein a scheduled |
| | STA can only transmit MPDU(s) addressed to its associated |
| | AP. |
| 2 | MU-RTS that initiates TXS procedure wherein a scheduled |
| | STA can transmit MPDU(s) addressed to its associated AP |
| | or addressed to another STA. |
| 3 | MU-RTS that initiates TXS procedure for a scheduled P2P |
| | group, wherein a non-AP STA member of the addressed P2P |
| | group can transmit MPDU(s) to another non-AP STA |
| | member of the same P2P group. |

FIG. 5A illustrates an example of HE variant User Info field format 500 in the MU-RTS TXS Trigger frame according to embodiments of the present disclosure. FIG. 5B illustrates an example of EHT variant User Info field 550 of MU-RTS TXS Trigger frame according to embodiments of the present disclosure. The embodiment of the formats of the HE variant User Info field format 500 and EHT variant User Info field 550 shown in FIGS. 5A-5B are for illustration only. Other embodiments could be used without departing from the scope of this disclosure.

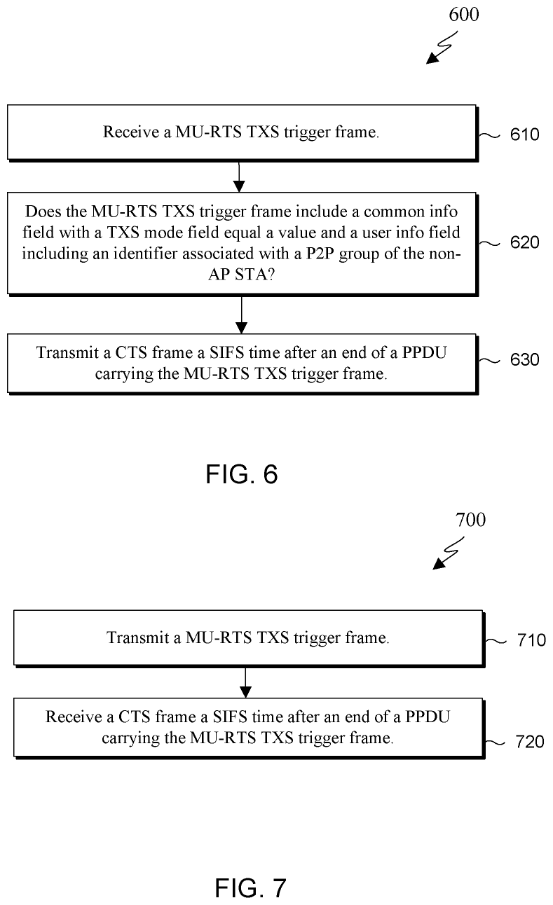

FIG. 6 illustrates an example method 600 for performed by a non-AP STA according to embodiments of the present disclosure. The method 600 of FIG. 6 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 600 is for illustration only and other embodiments can be used without departing from the scope of the present disclosure.

The method 600 begins with the non-AP STA receiving a MU-RTS TXS trigger frame (610). For example, in 610, the MU-RTS TXS trigger frame is received from an AP that may be associated with the non-AP STA. In various embodiments, the non-AP STA is a TXSPG non-AP STA capable of TXSPG and a TXSPG requesting STA that requested a TXOP for the P2P group.

The non-AP STA then determines whether the MU-RTS TXS trigger frame includes a common info field with a TXS mode field equal a value and a user info field including an identifier associated with a P2P group of the non-AP STA (620). The non-AP STA then transmits a CTS frame a SIFS time after an end of a PPDU carrying the MU-RTS TXS trigger frame (630). For example, in 630, the non-AP STA transmits the CTS frame if the MU-RTS TXS trigger frame includes the common info field with the TXS mode field equals the value and the user info field including the identifier associated with the P2P group of the non-AP STA as determined in 620.

In various embodiments, after transmission of the CTS frame, the non-AP STA transmits one or more PPDUs within a time allocation indicated in the MU-RTS TXS trigger frame. Frames within the transmitted one or more PPDUs are addressed to the AP or to another non-AP STA. In various embodiments, the non-AP STA, after transmission of the CTS frame, ignores an intra-BSS NAV either until an earlier of an end of a time allocation indicated in the MU-RTS TXS trigger frame or the time allocation is returned to a TXOP holder. In various embodiments, the non-AP STA, after sending the CTS frame, sets a duration/identifier field of following frames to indicate a time that is no later than an ending time of a PPDU plus signal extension carrying the MU-RTS TXS trigger frame plus an allocated time duration in an allocation duration field of the MU-RTS TXS trigger frame.

In various embodiments, the non-AP STA identifies, based on the MU-RTS TXS trigger frame, a time allocation within a TXOP of the AP for frame transmission for non-AP STAs in the P2P group. In various embodiments, the non-AP STA in the P2P group associated with the identifier in the user info field in the MU-RTS TXS trigger frame ensures that a PPDU transmissions of the non-AP STA and any expected responses to the PPDU transmissions fit entirely within an allocated time for the P2P group. In various embodiments, the non-AP STA, within a time allocated by the MU-RTS TXS trigger frame, transmits QoS data frames, management frames, and frames that assist transmission of the QoS data and management frames, including RTS/CTS frames, sounding frames, and acknowledgment frames.

In various embodiments, the non-AP STA receives, from the AP, a UHR capabilities element with a TXOP return support in TXSPG subfield set to 1. Based on the MU-RTS TXS trigger frame including the TXS mode field equal to the value, the non-AP STA transmits, to the AP within an allocated time, QoS data or a QoS null frame that includes an HE variant HT control field with a CAS control subfield with a RDG/more PPDU subfield set to 0. In various embodiments, when the MU-RTS TXS Trigger frame does not include the TXS mode field equal to the value, the non-AP STA does not transmit QoS data or a QoS null frame that includes an HE variant HT control field with a CAS control subfield with a RDG/more PPDU subfield set to 0 within a time allocated for the P2P group.

FIG. 7 illustrates an example method 700 for performed by an AP according to embodiments of the present disclosure. The method 700 of FIG. 7 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 700 is for illustration only and other embodiments can be used without departing from the scope of the present disclosure.

The method 700 begins with the AP transmitting a MU-RTS TXS trigger frame (710). For example, in 710, the MU-RTS TXS trigger frame is transmitted to a non-AP STA that may be associated with the AP. In various embodiments, the non-AP STA is a TXSPG non-AP STA capable of TXSPG and a TXSPG requesting STA that requested a TXOP for the P2P group.

The AP then receives a CTS frame a SIFS time after an end of a PPDU carrying the MU-RTS TXS trigger frame (720). For example, in 720, the CTS frame is received if the MU-RTS TXS trigger frame includes a common info field with a TXS mode field equal a value and a user info field including an identifier associated with a P2P group of the non-AP STA,

In various embodiments, after reception of the CTS frame, the non-AP STA transmits one or more PPDUs within a time allocation indicated in the MU-RTS TXS trigger frame. Frames within the transmitted one or more PPDUs are addressed to the AP or to another non-AP STA. In various embodiments, after reception of the CTS frame, the non-AP STA ignores an intra-BSS NAV either until an earlier of an end of a time allocation indicated in the MU-RTS TXS trigger frame or the time allocation is returned to a TXOP holder. In various embodiments, after receipt of the CTS frame, a duration/identifier field of following frames is set to indicate a time that is no later than an ending time of a PPDU plus signal extension carrying the MU-RTS TXS trigger frame plus an allocated time duration in an allocation duration field of the MU-RTS TXS trigger frame.

In various embodiments, the MU-RTS TXS trigger frame indicates a time allocation within a TXOP of the AP for frame transmission for non-AP STAs in the P2P group. In various embodiments, the non-AP STA in the P2P group associated with the identifier in the user info field in the MU-RTS TXS trigger frame ensures that a PPDU transmissions of the non-AP STA and any expected responses to the PPDU transmissions fit entirely within an allocated time for the P2P group. In various embodiments, the non-AP STA, within a time allocated by the MU-RTS TXS trigger frame, transmits QoS data frames, management frames, and frames that assist transmission of the QoS data and management frames, including RTS/CTS frames, sounding frames, and acknowledgment frames.

In various embodiments, the AP transmits, to the non-AP STA, a UHR capabilities element with a TXOP return support in TXSPG subfield set to 1. Based on the MU-RTS TXS trigger frame including the TXS mode field equal to the value, the AP receives, from the non-AP STA within an allocated time, QoS data or a QoS null frame that includes an HE variant HT control field with a CAS control subfield with a RDG/more PPDU subfield set to 0. In various embodiments, when the MU-RTS TXS Trigger frame does not include the TXS mode field equal to the value, the AP does not receive QoS data or a QoS null frame that includes an HE variant HT control field with a CAS control subfield with a RDG/more PPDU subfield set to 0 within a time allocated for the P2P group.

According to one embodiment, upon a TXSPG non-AP STA's reception of an MU-RTS TXS Trigger frame that meticulously satisfies a set of predefined criteria originating from its associated AP, a specific sequence of actions is initiated. The first of these condition mandates that the Common Info field within the received trigger frame must have its TXS Mode field unequivocally set to a value of 3, which, based on prior context, likely signifies a particular mode of TXOP allocation or management tailored for P2P groups. Simultaneously, the trigger frame must contain at least one User Info field that is explicitly addressed to a TXSPG Requesting STA, which is identified as a member of the same P2P group to which the receiving non-AP STA also belongs. Furthermore, to ensure the context is correctly scoped to the intended P2P communication, the P2P Group ID field within this specific User Info field must be precisely set to the P2P group ID of the very P2P group in which the receiving non-AP STA holds membership.

According to one embodiment, upon the concurrent fulfillment of all the aforementioned conditions within the received MU-RTS TXS Trigger frame, the TXSPG non-AP STA is obligated to immediately respond by transmitting a CTS frame. This transmission must occur precisely one SIFS duration after the complete reception of the PPDU that carried the MU-RTS TXS Trigger frame. This immediate CTS response serves as a positive acknowledgement to the AP, confirming the non-AP STA's successful reception of the trigger frame and its readiness to participate in the subsequent data exchange or channel access within the allocated time period. The timing criticality of the SIFS interval ensures a prioritized and expedited response, minimizing potential delays and maximizing the efficiency of the triggered channel access mechanism within the BSS.

According to one embodiment, subsequent to the transmission of the mandatory CTS frame, the TXSPG non-AP STA is granted the discretionary capability to initiate an Enhanced Distributed Channel Access (EDCA) backoff procedure. This initiation is contingent on the non-AP STA intending to transmit one or more non-Trigger-Based (non-TB) PPDUs within the temporal boundaries of the time allocation that was explicitly indicated in the preceding MU-RTS TXS Trigger frame. The EDCA backoff allows the non-AP STA to contend for the medium in a prioritized manner based on its traffic category, even within the TXOP that was originally managed by the AP but delegated for P2P communication. This mechanism provides flexibility for the non-AP STA to engage in data or control frame exchanges without direct polling from the AP during this allocated interval.

According to one embodiment, the non-TB PPDUs that the TXSPG non-AP STA may transmit following the EDCA backoff procedure can be directed towards one of two possible destinations. First, these PPDUs can be addressed to the associated AP itself, facilitating uplink data transfer, control signaling, or management frame exchanges between the non-AP STA and the infrastructure network. Second, and perhaps more pertinent in the context of TXSPG, these non-TB PPDUs can be addressed to another STA that is also a member of the same P2P group. This capability enables direct peer-to-peer communication within the BSS, leveraging the TXOP allocated by the AP but used for direct exchanges between the non-AP STAs that are part of the specified P2P group, enhancing localized communication efficiency.

According to one embodiment, an important responsibility is imposed upon the TXSPG non-AP STA: it must rigorously ensure that all of its PPDU transmissions, as well as any responses that it anticipates receiving as a direct consequence of these transmissions, must entirely fit within the finite duration of the time allocation that was signaled in the initial MU-RTS TXS Trigger frame. This necessitates careful management of frame lengths and expected acknowledgment frame durations by the transmitting non-AP STA. The standard does not explicitly dictate how the STA performs this management, leaving room for implementation-specific strategies, but the fundamental requirement is to avoid exceeding the allocated time, which could potentially disrupt other network operations or violate the TXOP boundaries.

According to one embodiment, following the transmission of the initial CTS frame in response to the MU-RTS TXS Trigger frame, the TXSPG non-AP STA is instructed to disregard the intra-BSS NAV for a specific period. This NAV typically indicates the predicted future busy status of the wireless medium, preventing STAs from attempting to transmit. However, in this scenario, the non-AP STA is allowed to operate within the allocated TXOP without being constrained by the NAV settings of other STAs in the BSS. This is crucial for enabling the P2P communication within the delegated time slot.

According to one embodiment, the duration for which the TXSPG non-AP STA is required to ignore the intra-BSS NAV is explicitly defined by two possible termination conditions, whichever occurs at an earlier time. The first condition is the natural expiration of the time allocation that was originally indicated within the MU-RTS TXS Trigger frame. Once this allocated duration has elapsed, the non-AP STA should resume its normal NAV observance behavior. The second condition is the event where the allocated time is explicitly returned to the original TXOP holder, which is typically the associated AP. This return mechanism could be triggered by a signal from the non-AP STA or through a time-out mechanism managed by the AP. Upon such a return, the non-AP STA should also cease ignoring the NAV. This dual termination condition ensures that the NAV ignoring behavior is strictly limited to the active P2P communication phase within the allocated TXOP.

According to one embodiment, a TXSPG non-AP STA, upon receiving an MU-RTS TXS Trigger frame from its associated AP, shall immediately transmit a CTS frame after a SIFS period. The CTS frame ensures that the channel is reserved for subsequent transmissions, preventing other devices from accessing the medium during the allocated time. The non-AP STA may then proceed to initiate an EDCA backoff procedure for transmitting one or more non-TB PPDUs within the time allocation specified in the trigger frame. These PPDUs can be directed to the AP or other STAs within the same P2P group, ensuring efficient communication within the group. The non-AP STA must ensure that all its transmissions and any expected responses, such as ACKs or block ACKs, fit entirely within the allocated time to avoid collisions and maintain proper channel utilization.

According to another embodiment, the TXSPG non-AP STA may prioritize the transmission of non-TB PPDUs based on the QoS parameters specified in the trigger frame. The User Info field may include additional subfields, such as traffic identification or priority levels, which the non-AP STA uses to determine the order and urgency of its transmissions. This prioritization ensures that high-priority data is transmitted first, minimizing latency for time-sensitive applications. The non-AP STA may also dynamically adjust its backoff procedure based on channel conditions, such as perceived congestion or interference, to optimize transmission efficiency while adhering to the allocated time constraints.

According to another embodiment, the TXSPG non-AP STA may utilize the P2P Group ID field in the MU-RTS TXS Trigger frame to identify multiple STAs within the same P2P group that are authorized to transmit during the allocated time. In this case, the non-AP STA may act as a coordinator, scheduling transmissions for other group members or distributing the allocated time among them. This functionality enables efficient multiplexing of the channel, allowing multiple STAs to share the same time allocation without conflicts. The non-AP STA may also use this mechanism to poll other STAs within the group, ensuring that all devices have an opportunity to transmit their data within the specified time.

According to another embodiment, the TXSPG non-AP STA may implement a mechanism to handle errors or unexpected interruptions during its transmission within the allocated time. For example, if a collision occurs or an ACK is not received, the non-AP STA may retry the transmission within the remaining allocation or adjust its backoff parameters to avoid further collisions. Additionally, the non-AP STA may generate a shortened CTS frame or use a different modulation and coding scheme (MCS) to quickly re-acquire the channel and resume transmissions. This ensures that the allocated time is used effectively, even in the presence of errors or interference.

According to another embodiment, the TXSPG non-AP STA may support multiple concurrent allocations by interpreting additional fields in the MU-RTS TXS Trigger frame. For instance, the trigger frame may specify different time slots or frequency bands for various STAs within the P2P group, allowing simultaneous transmissions without overlap. The non-AP STA must then ensure that its own transmissions align with the allocated slot and avoid interfering with others. This feature enhances the overall efficiency of the network by enabling parallel transmissions while maintaining strict adherence to the specified allocations.

According to another embodiment, the TXSPG non-AP STA may incorporate power-saving mechanisms during the allocated time period. For example, if the non-AP STA has no data to transmit within the specified allocation, it may enter a low-power state and ignore the intra-BSS NAV until the end of the allocation or until the time is returned to the TXOP holder. This reduces energy consumption while still maintaining compliance with the trigger frame's instructions. Additionally, the non-AP STA may signal its power-saving status to the AP or other STAs within the P2P group to avoid unnecessary transmissions directed toward it during this period.

According to another embodiment, the TXSPG non-AP STA may use the allocated time to transmit a burst of frames, such as aggregated MPDUs, to improve efficiency. The trigger frame may specify parameters for aggregation, such as the maximum size or number of frames, which the non-AP STA must adhere to while transmitting. By aggregating multiple frames into a single PPDU, the non-AP STA can reduce overhead and maximize throughput within the allocated time. This is particularly beneficial for applications requiring high data rates, such as video streaming or file transfers.

According to another embodiment, the TXSPG non-AP STA may implement a channel-sensing mechanism during the allocated time to dynamically adjust its transmissions based on real-time channel conditions. For instance, if the channel becomes busy or degraded due to interference, the non-AP STA may temporarily suspend its transmissions and resume once the channel improves, provided it is still within the allocated time. This adaptive behavior ensures that transmissions are only made when the channel can support them effectively, minimizing errors and retransmissions while adhering to the specified constraints.

According to another embodiment, the TXSPG non-AP STA may use the allocated time to initiate a series of control frame exchanges with other STAs in the P2P group. For example, after transmitting its CTS frame, the non-AP STA may poll other devices within the group to determine their transmission needs and allocate portions of the remaining time accordingly. This creates a distributed scheduling mechanism that maximizes channel utilization while maintaining compliance with the trigger frame's instructions. The non-AP STA may also use this opportunity to negotiate modifications to the allocation with the AP or other STAs, ensuring flexibility in response to changing network conditions.

According to another embodiment, the TXSPG non-AP STA may implement a mechanism for dynamic adjustment of the allocated time based on feedback from other STAs. For example, if a STA within the P2P group indicates that it requires additional time for its transmissions, the non-AP STA may extend or adjust its own transmissions accordingly, provided it stays within the overall limits specified by the trigger frame. This collaborative approach allows the network to adapt dynamically to varying demands while maintaining efficient channel utilization and adherence to the allocation constraints.

According to another embodiment, the TXSPG non-AP STA may use the allocated time to perform channel measurements or diagnostics, such as sounding or link adaptation. For example, after transmitting its CTS frame, the non-AP STA may send probe frames to other STAs within the P2P group to gather information about the channel conditions experienced by each device. This data can then be used to optimize future transmissions, such as selecting the most robust MCS or adjusting transmission power levels. By integrating these diagnostic functions within the allocated time, the non-AP STA ensures that the network operates at peak efficiency while adhering to the trigger frame's instructions.

According to another embodiment, the TXSPG non-AP STA may support multiple simultaneous allocations by interpreting additional fields in the MU-RTS TXS Trigger frame. For instance, the trigger frame may specify different time slots or frequency bands for various STAs within the P2P group, allowing parallel transmissions without overlap. The non-AP STA must then ensure that its own transmissions align with the allocated slot and avoid interfering with others. This feature enhances the overall efficiency of the network by enabling concurrent transmissions while maintaining strict adherence to the specified allocations.

According to another embodiment, the TXSPG non-AP STA may incorporate advanced scheduling algorithms to optimize the use of the allocated time. For example, the non-AP STA may prioritize transmissions based on factors such as data type, urgency, or destination, ensuring that critical data is transmitted first while less urgent data is scheduled for later within the allocation. Additionally, the non-AP STA may use predictive analytics to anticipate future transmission needs and adjust the STA's scheduling accordingly, further enhancing network performance and efficiency.

According to another embodiment, the TXSPG non-AP STA may implement a mechanism for handling multiple simultaneous allocations from different APs or STAs within the same P2P group. For example, if the non-AP STA receives trigger frames from multiple sources, it must prioritize and manage these allocations to avoid conflicts and ensure that all transmissions fit within their respective time constraints. This requires advanced coordination and scheduling capabilities, potentially involving dynamic allocation adjustments based on network conditions or priority levels.

According to another embodiment, the TXSPG non-AP STA may use the allocated time to transmit data in multiple frequency bands or channels simultaneously. For example, if the trigger frame specifies that the non-AP STA can utilize both 2.4 GHz and 5 GHz bands during its allocation, it may split its transmissions across these bands to maximize throughput while minimizing interference. This dual-band transmission capability allows the non-AP STA to fully leverage available spectrum resources within the constraints of the allocated time.

According to another embodiment, the TXSPG non-AP STA may implement a mechanism for dynamic adjustment of the allocated time based on feedback from other STAs in the P2P group. For instance, if a STA indicates that it requires additional time for its transmissions, the non-AP STA may extend or adjust its own transmissions accordingly, provided it stays within the overall limits specified by the trigger frame. This collaborative approach allows the network to adapt dynamically to varying demands while maintaining efficient channel utilization and adherence to the allocation constraints.

According to another embodiment, the TXSPG non-AP STA may use the allocated time to perform advanced link adaptation techniques, such as adjusting modulation and coding schemes (MCS) or transmission power levels based on real-time channel conditions. For example, after transmitting its CTS frame, the non-AP STA may continuously monitor the channel quality and adjust its transmission parameters to ensure optimal performance throughout the allocation period. This dynamic adaptation ensures that transmissions are both reliable and efficient, even in changing network environments.

According to another embodiment, the TXSPG non-AP STA may implement a mechanism for prioritizing transmissions based on application-specific requirements within the allocated time. For example, if the non-AP STA is transmitting data for real-time applications like voice or video, it may prioritize these transmissions over background data transfers to ensure low latency and high quality of service. This application-aware scheduling enhances user experience while adhering to the constraints specified in the trigger frame.

According to another embodiment, the TXSPG non-AP STA may use the allocated time to transmit a combination of unicast and multicast frames, depending on the requirements specified in the MU-RTS TXS Trigger frame. For instance, if the trigger frame indicates that both types of transmissions are allowed within the allocation, the non-AP STA may interleave unicast and multicast data to maximize channel utilization while ensuring that all intended recipients receive their respective data. This mixed transmission capability allows for flexible and efficient use of the allocated time.

According to another embodiment, the TXSPG non-AP STA may implement a mechanism for handling multiple concurrent allocations from different P2P groups or networks. For example, if the non-AP STA is part of more than one group, it must manage its transmissions across these groups to avoid conflicts and ensure that all allocations are respected. This requires advanced coordination capabilities, potentially involving dynamic allocation adjustments based on network conditions or priority levels.

According to another embodiment, the TXSPG non-AP STA may use the allocated time to transmit data in a manner that minimizes interference with other nearby networks or devices. For example, the non-AP STA may implement techniques such as frequency hopping or adaptive channel selection during its transmissions to avoid overlapping with other networks operating in the same band. This interference-mitigation strategy ensures that the non-AP STA's transmissions remain efficient and reliable while also being considerate of other wireless activities in the vicinity.

According to another embodiment, the TXSPG non-AP STA may implement a mechanism for dynamically adjusting its transmission parameters based on feedback from the AP or other STAs within the P2P group. For instance, if the AP provides updated information about channel conditions or network congestion during the allocated time, the non-AP STA can adjust its MCS, power levels, or data rate to optimize performance accordingly. This dynamic adjustment ensures that transmissions remain efficient and reliable throughout the allocation period.

According to another embodiment, the TXSPG non-AP STA may use the allocated time to implement advanced security features, such as encryption or authentication protocols, for its transmissions. For example, after transmitting its CTS frame, the non-AP STA may encrypt its data using a group-specific key derived from the P2P Group ID field in the trigger frame. This ensures that all transmissions within the allocation are secure and accessible only to authorized members of the P2P group, maintaining confidentiality and integrity of the communicated data.

According to another embodiment, the TXSPG non-AP STA may implement a mechanism for handling emergency or high-priority transmissions during the allocated time. For example, if an urgent message is received from the AP or another STA within the P2P group, the non-AP STA may preempt its scheduled transmissions and prioritize the urgent data to ensure timely delivery. This capability allows the network to quickly respond to critical events while still adhering to the overall constraints of the allocated time.

According to another embodiment, the TXSPG non-AP STA may use the allocated time to perform advanced diagnostics or troubleshooting within the P2P group. For example, after transmitting its CTS frame, the non-AP STA may send probe requests to other STAs in the group to gather information about their connection status, signal strength, or data transmission errors. This diagnostic data can then be used by the AP or other network management entities to identify and resolve issues affecting the group's performance.

According to another embodiment, the TXSPG non-AP STA may implement a mechanism for load balancing within the P2P group during the allocated time. For example, if one STA in the group is experiencing high traffic or congestion, the non-AP STA may redistribute some of its own transmission load to other STAs with available capacity, ensuring that the overall network performance remains optimal. This load-balancing capability allows the group to efficiently manage resources and maintain high throughput even under varying traffic conditions.

According to another embodiment, the TXSPG non-AP STA may use the allocated time to implement advanced routing or forwarding capabilities within the P2P group. For example, if the non-AP STA receives data from one STA in the group that is destined for another STA, it may act as a relay and forward the data during its own transmission opportunities within the allocation. This routing functionality allows the group to efficiently manage data distribution while minimizing the need for centralized coordination by the AP.

According to another embodiment, the TXSPG non-AP STA may implement a mechanism for dynamic adjustment of the allocated time based on the actual data requirements of the P2P group. For instance, if the non-AP STA determines that its transmissions will require less time than initially allocated, it may signal the AP or other STAs to release the remaining time early, allowing other devices to utilize the freed-up channel capacity. This dynamic adjustment ensures that channel resources are used efficiently and not left underutilized due to over-allocation.

According to another embodiment, the TXSPG non-AP STA may use the allocated time to implement advanced error correction techniques, such as forward error correction (FEC), for its transmissions. For example, after transmitting its CTS frame, the non-AP STA may encode its data with FEC codes to detect and correct errors caused by channel impairments, ensuring reliable delivery of data within the specified allocation period. This enhances transmission robustness, especially in noisy or unreliable channel conditions.

According to another embodiment, the TXSPG non-AP STA may implement a mechanism for cooperative transmission techniques within the P2P group during the allocated time. For example, if multiple STAs are transmitting data to a common destination, they may coordinate their transmissions to create a distributed antenna system, improving the overall signal quality and reliability at the receiver. This cooperative approach allows the group to achieve better performance than individual transmissions while adhering to the allocation constraints.

According to another embodiment, the TXSPG non-AP STA may use the allocated time to implement advanced data aggregation techniques, such as concatenating multiple frames into a single PPDU, to maximize throughput and efficiency. For example, after transmitting its CTS frame, the non-AP STA may aggregate several small data packets into one larger transmission unit, reducing overhead and increasing the overall data rate within the allocation period. This aggregation capability allows for more efficient use of available channel capacity.

According to another embodiment, the TXSPG non-AP STA may implement a mechanism for dynamic adjustment of its transmission power levels during the allocated time based on real-time channel conditions or network requirements. For example, if the AP indicates that the channel is experiencing high interference, the non-AP STA may increase the non-AP STA's transmit power to maintain reliable communication, while reducing it in quieter conditions to conserve energy and minimize interference.

According to another embodiment, the TXSPG non-AP STA may use the allocated time to implement advanced QoS mechanisms within the P2P group. For example, if the trigger frame specifies different QoS levels for various types of data, the non-AP STA may prioritize the non-AP STA's transmissions accordingly, ensuring that high-priority traffic is delivered with low latency and high reliability while lower-priority traffic is managed in a best-effort manner.

According to another embodiment, the TXSPG non-AP STA may implement a mechanism for handling multiple simultaneous connections or sessions within the P2P group during the allocated time. For example, if the non-AP STA needs to transmit data to multiple destinations within the group, it may manage these transmissions by interleaving them or using different transmission parameters (e.g., MCS, power levels) to optimize performance and ensure that all data is delivered efficiently.

According to another embodiment, the TXSPG non-AP STA may use the allocated time to implement advanced channel sounding techniques to improve the accuracy of channel state information (CSI). For example, after transmitting its CTS frame, the non-AP STA may send null data packets (NDPs) or other sounding frames to gather detailed feedback about the channel conditions from the receiver. This CSI can then be used to optimize transmission parameters such as MCS and beamforming to maximize throughput and reliability.

According to another embodiment, the TXSPG non-AP STA may implement a mechanism for dynamic adjustment of its transmission scheduling based on predictions of future network traffic patterns within the P2P group. For instance, if historical data or predictive analytics indicate that certain types of traffic will increase in volume during specific times, the non-AP STA can adjust its allocation requests and transmission strategies to prepare for these anticipated demands, ensuring smooth operation even under varying load conditions.

According to one embodiment, a TXSPG Requesting STA, upon receiving an MU-RTS TXS Trigger frame wherein the TXOP Sharing Mode subfield is explicitly set to a value of 3, is granted a conditional permission to transmit specific types of frames within the time allocated by the trigger frame. This transmission is limited to either a QoS Data frame, used for conveying prioritized data traffic, or a QoS Null frame, which typically serves purposes such as power management signaling or indicating the end of a data burst. A key aspect of these permissible frames is the inclusion of an HE variant HT Control field, a modified version of the standard HT Control field designed for HE networks. Within this HE variant HT Control field, the CAS Control subfield must have its RDG/More PPDU subfield set to a specific value of 0, which generally indicates that the current PPDU is not followed by another PPDU within the same TXOP under RDG or multi-PPDU transmission rules.

According to one embodiment, the ability of the TXSPG Requesting STA to transmit the aforementioned QoS Data or QoS Null frame with the specific HE variant HT Control field towards its associated AP is further contingent upon a capability advertised by the AP. Specifically, the associated AP must have previously indicated its support for TXOP return within a TXSPG context. This indication is conveyed through the inclusion of a UHR Capabilities element in the AP's signaling, where the TXOP Return Support in TXSPG subfield within this element is explicitly set to a value of 1. This subfield signifies the AP's willingness and ability to handle a situation where a non-AP STA, having been granted a portion of the TXOP for TXSPG purposes, might need to relinquish the remaining allocated time back to the AP before its natural expiration. Without this explicit advertisement of TXOP Return Support by the AP, the TXSPG Requesting STA is explicitly prohibited from transmitting such a frame to the AP within the allocated time.

According to one embodiment, this restriction ensures that the AP is prepared to manage and potentially reallocate any unused portion of the TXOP that was initially delegated for P2P communication within the TXSPG framework. By requiring the AP to explicitly signal its TXOP Return Support capability, the standard prevents situations where a non-AP STA might prematurely return the TXOP, and the AP is not equipped to handle this early relinquishment, potentially leading to inefficiencies or contention issues on the wireless medium. This mechanism facilitates a more coordinated and predictable utilization of the shared TXOP resources, particularly in scenarios where TXSPG is employed to enhance peer-to-peer communication within a managed infrastructure network.

According to one embodiment, in scenarios where the associated AP has not advertised the UHR Capabilities element with the TXOP Return Support in TXSPG subfield set to 1, the TXSPG Requesting STA is constrained in its ability to communicate with the AP within the time allocated by an MU-RTS TXS Trigger frame with TXOP Sharing Mode equal to 3. This limitation does not necessarily preclude all forms of communication with other STAs within the P2P group during the allocated time, as per the broader provisions of TXSPG. However, it specifically restricts the transmission of QoS Data or QoS Null frames with the specified HE variant HT Control field back to the AP, likely to avoid potential issues related to TXOP management and return procedures that the AP has not explicitly signaled its readiness for.

According to one embodiment, a fundamental requirement for any TXSPG STA that is part of a P2P group and is addressed by an MU-RTS TXS Trigger frame is the imperative to ensure that all of its PPDU transmissions initiated within the allocated time, as well as any subsequent response PPDUs that are expected as a direct consequence of these transmissions, must entirely fit within the temporal boundaries of the time allocation specified in the trigger frame. This encompasses not only the transmission duration of the initial frame(s) sent by the TXSPG STA but also the anticipated duration of acknowledgment frames, block acknowledgments, or any other response frames that the transmitting STA expects to receive from the intended recipient(s), whether it be the AP or another STA within the P2P group.

According to one embodiment, this constraint on the transmission and response durations is critical for maintaining the integrity of the TXOP sharing mechanism and preventing any single TXSPG STA from unduly occupying the wireless medium beyond its allocated slot. By adhering to this requirement, TXSPG STAs contribute to a more efficient and fair utilization of the shared TXOP, minimizing the potential for collisions, interference, or delays for other STAs that might be scheduled to transmit within subsequent time slots or concurrently using other spatial streams or frequency resources. The responsibility for managing these durations lies with the transmitting TXSPG STA, necessitating careful consideration of PHY rates, frame lengths, and expected response times.

According to one embodiment, a TXSPG STA could employ various strategies to ensure its transmissions and expected responses fit within the allocated time. For instance, the STA might select a higher PHY rate to reduce the transmission duration of its frames. Alternatively, it might segment larger data payloads into smaller frames to better manage the transmission timeline and the potential for retransmissions within the given slot. Furthermore, the STA would need to account for the interframe spaces (IFSs) required between its transmissions and the expected responses, as well as the duration of the response frames themselves, to guarantee compliance with the allocated time window. This self-management of the transmission timeline is a key aspect of the distributed coordination enabled by the TXSPG mechanism.

According to one embodiment, when a TXSPG Requesting STA receives an MU-RTS TXS Trigger frame with the TXOP Sharing Mode subfield set to 3, it may transmit a QoS Data or QoS Null frame to the associated AP within the allocated time. This transmission must include an HE variant HT Control field with the CAS Control subfield, where the RDG/More PPDU subfield is set to 0. The STA is only permitted to perform this action if it has previously received a UHR

Capabilities element from the AP with the TXOP Return Support in TXSPG subfield set to 1. This ensures that the AP supports the return of TXOP after the STA's transmission, maintaining efficient channel utilization and adherence to the protocol's timing constraints.

According to one embodiment, if the TXOP Sharing Mode subfield is not equal to 3, or if the TXOP Return Support in TXSPG subfield in the UHR Capabilities element is not set to 1, the STA must refrain from transmitting such a frame within the allocated time. This prevents unauthorized or unsupported transmissions that could disrupt the coordinated operation of the wireless network. The STA may instead wait for further instructions or use alternative mechanisms to request channel access, ensuring compliance with the AP's capabilities and maintaining network stability.

According to one embodiment, the TXSPG STA in a P2P group addressed by an MU-RTS TXS Trigger frame must carefully plan its PPDU transmissions to ensure they fit entirely within the allocated time. This includes not only the data transmission itself but also any expected responses, such as ACK frames or other control messages. The STA may use timing calculations based on the PPDU duration and the remaining time in the TXOP allocation to determine if its intended transmission can be completed without causing overlaps or conflicts with subsequent transmissions from other STAs.

According to one embodiment, the STA may implement a backoff mechanism if it determines that its PPDU transmission cannot fit within the allocated time. This involves deferring its transmission until a future TXOP allocation or using an alternative channel access method, such as contention-based access, to avoid collisions and maintain efficient network operation. The STA may also adjust its transmission parameters, such as data rate or frame size, to minimize the duration of its PPDU and ensure it fits within the allocated time constraints.

According to one embodiment, the STA may include additional control information in the HE variant HT Control field to indicate its ability to comply with the TXOP allocation. For example, the CAS Control subfield may be used to signal to the AP that the STA has adjusted its transmission parameters or deferred its transmission as needed to fit within the allocated time. This provides the AP with feedback on the STA's compliance and enables dynamic adjustments to future TXOP allocations based on the STA's capabilities and behavior.

According to one embodiment, the STA may monitor the received UHR Capabilities element from the AP to determine if it is allowed to transmit during the allocated time. If the TXOP Return Support in TXSPG subfield is set to 1, the STA proceeds with its transmission as described; otherwise, it must refrain from transmitting. This ensures that the STA only transmits when explicitly supported by the AP, maintaining compliance with the network's configuration and preventing unauthorized access.

According to one embodiment, the STA may implement error handling mechanisms if it receives an MU-RTS TXS Trigger frame with conflicting or invalid parameters. For example, if the TXOP Sharing Mode subfield is set to a value that the STA does not support, or if the allocated time is insufficient for its intended transmission, the STA may send a response indicating the issue or simply ignore the trigger frame. This prevents errors from propagating through the network and ensures that only valid and supported transmissions are attempted.

According to one embodiment, the STA may use power-saving mechanisms in conjunction with TXOP allocations to optimize energy efficiency. For example, if the STA operates in a low-power mode, it may adjust its wake-up schedule based on the allocated time and the expected duration of its PPDU transmission. This ensures that the STA is active only when necessary, reducing power consumption while still meeting the timing constraints imposed by the TXOP allocation.

According to one embodiment, the STA may interact with other STAs in the P2P group to coordinate their transmissions and ensure that all PPDU transmissions fit within the allocated time. This may involve exchanging control frames or using a centralized scheduling mechanism provided by the AP. By coordinating transmissions, the STAs can avoid collisions and make efficient use of the shared channel, maximizing throughput while adhering to the protocol's requirements.

According to one embodiment, the STA may implement a fallback mechanism if it is unable to transmit within the allocated time due to unforeseen conditions, such as channel congestion or interference. This may involve retransmitting the frame during a subsequent TXOP allocation or using an alternative channel access method. The STA may also provide feedback to the AP regarding the cause of the failure, enabling the AP to adjust future TXOP allocations or take other corrective actions to improve network performance.

According to one embodiment, the STA may use the RDG/More PPDU subfield in the CAS Control field to indicate whether additional PPDU transmissions will follow. If this subfield is set to 1, the AP and other STAs are notified that more transmissions are pending, allowing them to adjust their channel access behavior accordingly. This enhances network efficiency by enabling better coordination among STAs and reducing the likelihood of collisions or unnecessary delays.

According to one embodiment, the STA may dynamically adjust its PPDU transmission parameters based on the allocated time and the current network conditions. For example, if the allocated time is shorter than expected due to a smaller TXOP allocation, the STA may reduce its data rate or frame size to ensure that its transmission can still be completed within the available time. This dynamic adjustment ensures that the STA's transmissions remain efficient and compliant with the network's constraints.

According to one embodiment, the STA may use the UHR Capabilities element to negotiate specific transmission parameters with the AP. For example, if the TXOP Return Support in TXSPG subfield is set to 1, the STA may request a longer TXOP allocation or additional control over the channel access timing to accommodate its transmission requirements. This negotiation process allows for a more flexible and efficient use of network resources while maintaining adherence to the protocol's specifications.

According to one embodiment, the STA may implement quality-of-service (QoS) enhancements to prioritize certain types of traffic during the allocated time. For example, if the STA is transmitting QoS Data or QoS Null frames, it may assign higher priority to these transmissions to ensure they are delivered promptly and without interruption. This prioritization helps maintain service levels and user experience in scenarios where multiple STAs are competing for channel access.

According to one embodiment, the STA may use the HE variant HT Control field to provide additional information about its transmission capabilities or requirements. For example, the CAS Control subfield may include details about the STA's buffer status, power constraints, or other factors that could impact its ability to transmit within the allocated time. This information enables the AP and other STAs to make more informed decisions about channel access and resource allocation.

According to one embodiment, the STA may support multiple TXOP allocations from different APs or P2P groups simultaneously. In such cases, the STA must carefully manage its PPDU transmissions to ensure that they fit within each allocated time slot without causing conflicts between different networks or groups. This involves complex scheduling algorithms and precise timing mechanisms to maintain compliance with all applicable constraints.

According to one embodiment, the STA may implement a mechanism to handle overlapping TXOP allocations from multiple sources. For example, if the STA receives MU-RTS TXS Trigger frames from two different APs or P2P groups with overlapping allocated times, it must determine which transmission to prioritize based on network policies or QoS requirements. This ensures that the STA's transmissions remain efficient and compliant even in complex multi-network environments.

According to one embodiment, the STA may use historical data and predictive analytics to optimize its PPDU transmissions within allocated time slots. For example, if the STA notices a pattern of frequent TXOP allocations with shorter durations, it may adjust its transmission parameters proactively to improve efficiency and reduce the likelihood of timing conflicts. This proactive approach enhances network performance by enabling the STA to anticipate and adapt to changing conditions.

According to one embodiment, the STA may interact with other STAs in the network to share information about TXOP allocations and PPDU transmissions. For example, neighboring STAs may exchange control frames containing details about their allocated times and transmission plans to avoid collisions and optimize channel usage. This collaborative approach improves overall network efficiency by enabling STAs to coordinate their actions more effectively.

According to one embodiment, the STA may use advanced error correction mechanisms to handle corrupted or lost frames during PPDU transmissions within the allocated time. For example, if a QoS Data frame is corrupted due to interference, the STA may implement FEC or retransmission requests to ensure reliable data delivery. This enhances the robustness of the network by minimizing the impact of errors on transmission efficiency and user experience.

According to one embodiment, the STA may support multiple wireless standards or variants simultaneously, such as Wi-Fi 6 and Wi-Fi 7, each with their own TXOP allocation mechanisms. In this case, the STA must ensure that its PPDU transmissions comply with the specific timing constraints of each standard while efficiently managing channel access across all supported protocols. This requires advanced scheduling algorithms and precise timing mechanisms to maintain performance and compatibility.

According to one embodiment, the STA may implement a feedback loop with the AP to refine TXOP allocations based on transmission outcomes. For example, if the STA consistently completes its PPDU transmissions well within the allocated time, it may provide feedback to the AP requesting smaller TXOP allocations in the future to free up channel resources for other STAs. Conversely, if transmissions frequently exceed the allocated time, the STA may request larger allocations or suggest adjustments to optimize network performance.

According to one embodiment, the STA may use machine learning techniques to optimize its PPDU transmission strategies within allocated time slots. For example, the STA could analyze historical data on channel conditions, TXOP durations, and transmission outcomes to develop predictive models that guide its future transmissions. This enables the STA to make more informed decisions about transmission parameters, such as data rate and frame size, to maximize efficiency while adhering to timing constraints.

According to one embodiment, the STA may integrate with other wireless technologies, such as Bluetooth or cellular networks, to coordinate PPDU transmissions across different communication channels. For example, the STA could use information from a cellular network about upcoming TXOP allocations to optimize its Wi-Fi transmissions and avoid conflicts between the two networks. This cross-technology coordination enhances overall device connectivity and performance in heterogeneous network environments.

According to one embodiment, a TXSPG STA within a P2P group, having been successfully addressed and having responded with a CTS frame as solicited by an MU-RTS TXS Trigger frame operating in Mode-3, is required to carefully manage the time indicated in the Duration/ID field of its subsequent frame transmissions. Specifically, the Duration/ID field in any QoS Data frame, Management frame, or any auxiliary frame transmitted by this STA within its allocated time slot must be set to a value that ensures the transmission does not extend beyond a precisely calculated end time. This end time is determined by adding the duration specified in the Allocation Duration field of the initial MU-RTS TXS (e.g., Mode-3) Trigger frame to the point in time when the PPDU carrying the trigger frame, potentially inclusive of any Signal Extension (SigExt), concludes its reception at the TXSPG STA. This mechanism provides a clear temporal boundary for the TXSPG STA's activity, preventing it from encroaching upon the transmission opportunities of other STAs or disrupting the overall time-division multiplexing scheme facilitated by the MU-RTS TXS framework.

According to one embodiment, this meticulous setting of the Duration/ID field serves as a protective measure, implicitly informing other STAs observing the wireless medium (through network allocation vector, NAV) about the remaining duration of the TXSPG STA's allocated slot. By accurately reflecting the time until the end of its permitted transmission window, the TXSPG STA helps to avoid unintended contention or interference from other devices that might otherwise assume the medium is free after the initial CTS response. This is particularly crucial in densely populated wireless environments where efficient time sharing is paramount for maintaining network performance and stability. Furthermore, this mechanism aligns with the fundamental principles of carrier sense multiple access with collision avoidance (CSMA/CA) by providing a predictable duration for channel occupancy.

According to one embodiment, the allocated time duration, as signaled in the Allocation Duration field of the MU-RTS TXS (Mode-3) Trigger frame, represents the total time granted to the TXSPG STA for its transmissions and any immediate responses. This duration begins immediately after the Short Interframe Space (SIFS) interval following the reception of the CTS frame transmitted by the TXSPG STA. Therefore, when calculating the value for the Duration/ID field of its subsequent frames, the TXSPG STA must account for the remaining portion of this allocated time, ensuring that its transmissions, including any potential acknowledgments it expects to receive, conclude before this allocated duration expires. This necessitates a careful estimation of the transmission time for each frame based on the selected modulation and coding scheme (MCS) and the frame length.

According to one embodiment, within the temporal confines established by the MU-RTS TXS Trigger frame's allocation, a TXSPG STA is afforded the flexibility to transmit a variety of frame types that are pertinent to its communication objectives within the P2P group. These permissible frame types explicitly include QoS Data frames, which are the primary means for exchanging prioritized user traffic, and Management frames, which serve various control and administrative functions within the wireless network, such as association, disassociation, and authentication. This broad allowance ensures that the TXSPG STA can conduct meaningful communication during its allocated slot.

According to one embodiment, recognizing that some data and management frame exchanges might benefit from enhanced reliability or require negotiation, the specification further permits the transmission of frames that directly assist in the successful delivery of QoS Data and Management frames. A prime example of such auxiliary frames is the Request to Send/Clear to Send (RTS/CTS) frame exchange. By preceding a larger data or management frame with an RTS/CTS sequence, the TXSPG STA can reserve the medium for the subsequent transmission, reducing the risk of collisions from hidden nodes. Similarly, sounding frames, which are used for channel estimation and beamforming purposes, may also be transmitted if they contribute to optimizing the link quality for the subsequent transmission of QoS Data or Management frames within the allocated time.

According to one embodiment, a variation on this could involve the transmission of Block Acknowledgement Request (BAR) frames and their corresponding Block Acknowledgement (BA) frames. If the TXSPG STA intends to transmit a series of QoS Data frames, it might initiate a block acknowledgment agreement within its allocated time by sending a BAR frame. The subsequent BA frame from the receiver, also transmitted within the allocated time, allows for more efficient acknowledgment of multiple data frames, thereby improving throughput. This demonstrates how the TXSPG STA can leverage MAC layer mechanisms to optimize its communication within the given time slot.

According to one embodiment, it is crucial to note that while the specification provides a degree of flexibility in the types of frames that can be transmitted, the overarching constraint remains that all transmissions and expected responses must fit entirely within the allocated duration. This necessitates careful planning and prioritization by the TXSPG STA. For instance, if the allocated time is relatively short, the STA might prioritize the transmission of essential QoS Data frames over less critical Management frames or might choose not to engage in lengthy RTS/CTS exchanges if the remaining time is insufficient for the subsequent data transmission and its acknowledgment. This balancing act between utilizing the allocated time effectively and adhering to the temporal boundaries is a key responsibility of the TXSPG STA operating within the MU-RTS TXS framework in Mode-3.

According to one embodiment, when a TXSPG STA in a P2P group receives an MU-RTS TXS Trigger frame in Mode 3 and subsequently sends a CTS, it must set the Duration/ID field of its subsequent frames to accurately reflect the allocated time. This ensures that other STAs in the network are aware of the expected channel occupancy duration, preventing unintended interference or collisions. The STA calculates this duration based on the ending time of the PPDU carrying the MU-RTS TXS Trigger frame and adds the allocated time specified in the Allocation Duration field of the trigger frame. This precise calculation is crucial for maintaining orderly channel access and ensuring that all transmissions stay within their designated time slots.

According to one embodiment, after sending the CTS, the TXSPG STA may transmit a variety of frames within the allocated time, including QoS Data frames, Management frames, and supporting frames like RTS/CTS or sounding frames. The inclusion of QoS Data frames ensures that high-priority data is transmitted efficiently, while Management frames are used for maintaining network connections and configurations. Supporting frames such as RTS/CTS facilitate better channel utilization by reducing collisions, and sounding frames help in optimizing transmission parameters like beamforming. This comprehensive set of allowable frame types ensures robust and efficient communication within the allocated time.

According to one embodiment, if the TXSPG STA fails to receive a CTS after sending an MU-RTS TXS Trigger frame, it should handle this scenario gracefully by retrying the CTS transmission or employing an alternative channel access method. This prevents the STA from incorrectly assuming channel availability and reduces the risk of collisions with other STAs. The STA may also adjust the STA's retry mechanism based on network conditions, such as backoff algorithms or dynamic retransmission attempts, to optimize recovery from potential failures.

According to one embodiment, the TXSPG STA can integrate power-saving mechanisms during the allocated time to enhance energy efficiency. For example, the STA may enter a low-power state between transmissions or adjust its wake-up schedule based on the remaining allocated time. This approach ensures that the STA minimizes power consumption without compromising its ability to adhere to the transmission timeline specified by the MU-RTS TXS Trigger frame.

According to one embodiment, the Duration/ID field calculation can be influenced by interactions with other STAs in the P2P group. The TXSPG STA must ensure that its calculated duration does not overlap with transmissions from other STAs addressed by the same MU-RTS TXS Trigger frame. This coordination is essential for maintaining seamless communication and preventing channel contention, especially in dense network environments where multiple STAs may be vying for channel access.

According to one embodiment, the TXSPG STA may set the Duration/ID field by incorporating additional parameters such as channel conditions and traffic type. This method ensures that the duration is not only based on existing PPDU end time and allocation fields but also considers real-time factors like interference levels and QoS requirements. By dynamically adjusting the duration, the STA can optimize transmission efficiency and reduce potential collisions.

According to another embodiment, within the allocated time frame, the TXSPG STA prioritizes frame types, ensuring critical data is transmitted first. This prioritization could be based on QoS markings or network policies, enhancing overall network performance and user experience by minimizing delays for high-priority traffic.

According to another embodiment, the TXSPG STA adjusts the duration dynamically using feedback from the receiver or channel conditions. This adaptive approach allows the STA to extend or truncate the transmission window as needed, ensuring efficient use of bandwidth and maintaining reliable connections even in fluctuating environments.

According to another embodiment, sounding frames are employed by the TXSPG STA to gather CSI, enhancing transmission efficiency. By analyzing CSI, the STA can optimize or improve data rates and transmission techniques like beamforming, ensuring robust and efficient data delivery during the allocated period.

According to another embodiment, when multiple TXSPGs are addressed, the AP employs OFDMA to enable concurrent transmissions. This technique maximizes bandwidth utilization by allowing multiple STAs to transmit simultaneously on different subchannels, thus enhancing overall network throughput and efficiency.

According to another embodiment, the allocation duration is determined by a centralized scheduler considering all TXSPGs' needs. This approach ensures fair and efficient resource distribution, preventing contention and optimizing the use of available bandwidth across the network.

According to another embodiment, the allocated time frame includes enhanced security features such as encryption and authentication protocols. This ensures that all data transmitted during this period is secure, protecting against potential eavesdropping or unauthorized access.

According to another embodiment, an AI or machine learning algorithm is used to predict optimal allocation durations based on historical data. This predictive approach allows the network to dynamically adjust and optimize resource allocations, improving performance and efficiency by anticipating traffic patterns and channel conditions.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a non-access point (AP) station (STA), the method comprising:
receiving, from an AP, a multi-user (MU)-request to send (RTS) transmission opportunity (TXOP) sharing (TXS) trigger frame;
determining whether the MU-RTS TXS trigger frame includes (i) a common info field with a TXS mode field equal a value and (ii) a user info field including an identifier associated with a peer to peer (P2P) group of the non-AP STA; and
transmitting, based on determining that the MU-RTS TXS trigger frame includes (i) the common info field with the TXS mode field equal the value and (ii) the user info field including the identifier associated with the P2P group of the non-AP STA, a clear to send (CTS) frame a short interframe space (SIFS) time after an end of a physical layer protocol data unit (PPDU) carrying the MU-RTS TXS trigger frame.

2. The method of claim 1, further comprising:
after transmission of the CTS frame, transmitting one or more PPDUs within a time allocation indicated in the MU-RTS TXS trigger frame,
wherein frames within the transmitted one or more PPDUs are addressed to the AP or to another non-AP STA.

3. The method of claim 1, further comprising:
after transmission of the CTS frame, ignoring an intra-basic service set (BSS) network allocation vector (NAV) either until an earlier of: (i) an end of a time allocation indicated in the MU-RTS TXS trigger frame or (ii) the time allocation is returned to a TXOP holder.

4. The method of claim 1, further comprising:
receiving, from the AP, a ultra-high reliability (UHR) capabilities element with a TXOP return support in TXOP sharing for peer to peer group (TXSPG) subfield set to 1; and
based on the MU-RTS TXS Trigger frame including the TXS mode field equal to the value, transmitting, to the AP within an allocated time, quality of service (QoS) data or a QoS null frame that includes an high efficiency (HE) variant high throughput (HT) control field with a command and status (CAS) control subfield with a reverse direction grant (RDG)/more PPDU subfield set to 0.

5. The method of claim 1, wherein, when the MU-RTS TXS Trigger frame does not include the TXS mode field equal to the value, the non-AP STA does not transmit a quality of service (QoS) data frame or a QoS null frame that includes an high efficiency (HE) variant high throughput (HT) control field with a command and status (CAS) control subfield with a reverse direction grant (RDG)/more PPDU subfield set to 0 within a time allocated for the P2P group.

6. The method of claim 1, wherein the non-AP STA in the P2P group associated with the identifier in the user info field in the MU-RTS TXS trigger frame ensures that a PPDU transmissions of the non-AP STA and any expected responses to the PPDU transmissions fit entirely within an allocated time for the P2P group.

7. The method of claim 1, further comprising:
after sending the CTS frame, setting a duration/identifier field of following frames to indicate a time that is no later than an ending time of a PPDU plus signal extension carrying the MU-RTS TXS trigger frame plus an allocated time duration in an allocation duration field of the MU-RTS TXS trigger frame.

8. The method of claim 1, further comprising:
within a time allocated by the MU-RTS TXS trigger frame, transmitting quality of service (QoS) data frames, management frames, and frames that assist transmission of the QoS data and management frames, including RTS/CTS frames, sounding frames, and acknowledgment frames.

9. The method of claim 1, further comprising:
identifying, based on the MU-RTS TXS trigger frame, a time allocation within a TXOP of the AP for frame transmission for non-AP STAs in the P2P group.

10. The method of claim 1, wherein:
the non-AP STA is a TXOP sharing for peer to peer group (TXSPG) non-AP STA capable of TXSPG, and
a TXSPG requesting STA that requested a TXOP for the P2P group.

11. A method performed by an access point (AP), the method comprising:
transmitting, to a non-AP station (STA), a multi-user (MU)-request to send (RTS) transmission opportunity (TXOP) sharing (TXS) trigger frame; and
receiving, when the MU-RTS TXS trigger frame includes (i) a common info field with a TXS mode field equal a value and (ii) a user info field including an identifier associated with a peer to peer (P2P) group of the non-AP STA, a clear to send (CTS) frame a short interframe space (SIFS) time after an end of a physical layer protocol data unit (PPDU) carrying the MU-RTS TXS trigger frame.

12. The method of claim 11, wherein:
after reception of the CTS frame, one or more PPDUs are transmitted within a time allocation indicated in the MU-RTS TXS trigger frame, and
frames within the transmitted one or more PPDUs are addressed to the AP or to another non-AP STA.

13. The method of claim 11, wherein, after reception of the CTS frame, the non-AP STA ignores an intra-basic service set (BSS) network allocation vector (NAV) either until an earlier of: (i) an end of a time allocation indicated in the MU-RTS TXS trigger frame or (ii) the time allocation is returned to a TXOP holder.

14. The method of claim 11, further comprising:
transmitting, to the non-AP STA, a ultra-high reliability (UHR) capabilities element with a TXOP return support in TXOP sharing for peer to peer group (TXSPG) subfield set to 11; and
based on the MU-RTS TXS Trigger frame including the TXS mode field equal to the value, receiving, from the STA within an allocated time, quality of service (QoS) data or a QoS null frame that includes an high efficiency (HE) variant high throughput (HT) control field with a command and status (CAS) control subfield with a reverse direction grant (RDG)/more PPDU subfield set to 0.

15. The method of claim 11, wherein, when the MU-RTS TXS Trigger frame does not include the TXS mode field equal to the value, the AP does not receive a quality of service (QoS) data frame or a QoS null frame that includes an high efficiency (HE) variant high throughput (HT) control field with a command and status (CAS) control subfield with a reverse direction grant (RDG)/more PPDU subfield set to 0 within a time allocated for the P2P group.

16. The method of claim 11, wherein the non-AP STA in the P2P group associated with the identifier in the user info field in the MU-RTS TXS trigger frame ensures that a PPDU transmissions of the non-AP STA and any expected responses to the PPDU transmissions fit entirely within an allocated time for the P2P group.

17. The method of claim 11, wherein, after reception of the CTS frame, a duration/identifier field of following frames is set to indicate a time that is no later than an ending time of a PPDU plus signal extension carrying the MU-RTS TXS trigger frame plus an allocated time duration in an allocation duration field of the MU-RTS TXS trigger frame.

18. The method of claim 11, wherein quality of service (QoS) data frames, management frames, and frames that assist transmission of the QoS data and management frames, including RTS/CTS frames, sounding frames, and acknowledgment frames are transmitted within a time allocated by the MU-RTS TXS trigger frame.

19. The method of claim 11, wherein the MU-RTS TXS trigger frame indicates a time allocation within a TXOP of the AP for frame transmission for non-AP STAs in the P2P group.

20. The method of claim 11, wherein:
the non-AP STA is a TXOP sharing for peer to peer group (TXSPG) non-AP STA capable of TXSPG, and
a TXSPG requesting STA that requested a TXOP for the P2P group.
